(19) United States
(12) Patent Application Publication
(10) Pub. No.: US 2011/0057828 A1
(43) Pub. Date: Mar. 10, 2011

(54) Mapping Method Implementing a Passive Radar

(75) Inventor: Jean-Philippe Brunet, Les Ulis (FR)

(73) Assignee: THALES, Neuilly sur Seine (FR)

(21) Appl. No.: 12/744,046

(22) PCT Filed: Nov. 24, 2008
(86) PCT No.: PCT/EP2008/066079

§ 371 Date: Nov. 23, 2010

(30) Foreign Application Priority Data
Nov. 23, 2007 (FR) 07 08213

(51) Int. Cl. G01S 13/50

(52) U.S. Cl. 342/28

(57) ABSTRACT

The invention relates to a mapping method implementing a radar used in passive mode. It is possible to use such a radar for locating an object likely to reflect an electromagnetic wave transmitted by a transmitter the position of which is known. Movable objects (3) capable of reflecting rays received from transmitters of opportunity (2) are used. The method comprises the following operations:
determining, in a distance Doppler matrix of the radar (1), points relative to the deviations between the rays received directly from the transmitters (2) and the rays reflected by the movable object (3),
transferring to a map to be established a probable zone of location of singularities of the electromagnetic field transmitted or reflected by the ground,
crossing several probable zones during the movement of the movable object (3) in order to obtain the location of the singularities.

The invention relates to a mapping method implementing a radar used in passive mode. It is possible to use such a radar to locate an object capable of reflecting an electromagnetic wave transmitted by a transmitter the position of which is known.

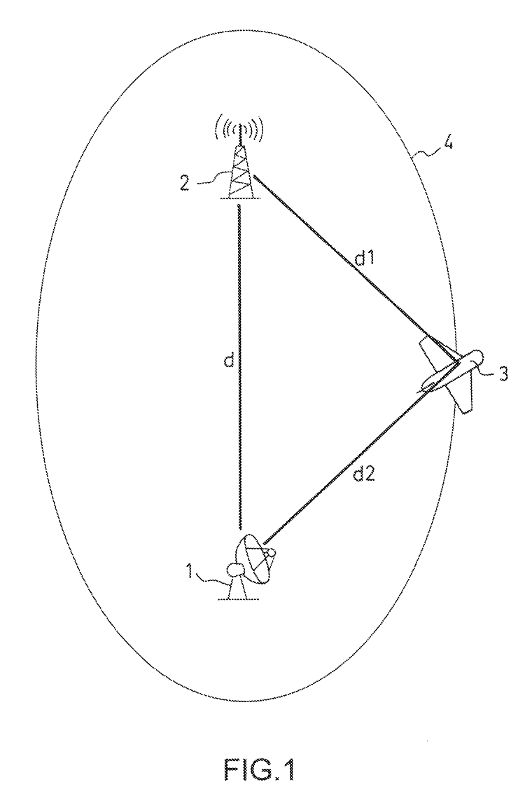

FIG. 1 makes it possible to explain briefly a principle of location. A radar 1 receives a first ray originating directly from a transmitter 2 and a second ray originating also from the transmitter 2 but reflected by an object 3 the position of which it is desired to determine. A distance d traveled by the first ray is defined. Since the position of the radar 1 and that of the transmitter are known, the distance d is therefore known. Also defined is a distance d1 separating the transmitter 2 from the object 3 and a distance d2 separating the object 3 from the radar 1.

The radar 1, receiving both rays, can define a distance deviation r between the distance d traveled by the first ray and the distance d1+d2 traveled by the second ray. In other words:

r=d1+d2−d (1)

or else:

d+r=d1+d2 (2)

In the equation (2) d+r being known, the position of the object is situated on an ellipse 4 of equation (2) the focus points of which are the radar 1 and the transmitter 2. The ellipse 4 is situated in a plane passing through the radar 1, the transmitter 2 and the object 3. More generally, knowing only the position of the radar 1 and of the transmitter 2, the object is situated on an ellipsoid of revolution about an axis passing through the radar 1 and the transmitter 2.

Based on several transmitters of distinct position, it is possible to define several ellipsoids on which the object is situated. The position of the object will be defined by a common intersection of the various ellipsoids.

It may happen that transmitters exist but that no transmitter position is known. The principle of location described above cannot then be used. It may also happen that the transmitters of which the position is known are limited in number, which reduces the accuracy in the location of the object.

Not knowing the position of the transmitters is often accompanied by not knowing the terrain and notably the electromagnetic field reflected by the ground.

It may be necessary to establish an electromagnetic field map relative to a given transmitter. For example, in radio broadcasting, such a map makes it possible to know the range of the transmitter and the possible shadow zones not covered by the transmitter. It is possible to carry out this type of mapping by moving a receiver over the whole zone and by measuring at each point the ray received from the transmitter. This method is cumbersome because it requires physically moving over the whole surface of the zone.

The object of the invention is to alleviate all or some of the problems cited above by proposing a mapping method implementing a passive radar that is fixed and using movable reflective objects such as aircraft overflying the zone to be mapped.

Accordingly, the subject of the invention is a mapping method implementing a passive radar and at least one movable capable of reflecting rays received from transmitters of opportunity, characterized in that it comprises the following operations:
determining, in a distance Doppler matrix of the radar, points relative to the deviations between the rays received directly from the transmitters and the rays reflected by the movable object,
transferring to a map to be established a probable zone of location of singularities of the electromagnetic field transmitted or reflected by the ground,
crossing several probable zones during the movement of the movable object in order to obtain the location of the singularities.

Amongst the singularities of the electromagnetic field, it is possible to locate the transmitters of opportunity from which the signal is received either directly or after reflection. It is also possible to locate all the variations of the electromagnetic field reflected by the ground in order to establish a complete mapping of a zone situated close to the passive radar and overflown by movable objects such as, for example, aircraft.

Using movable objects makes it possible to select only the rays reflected by the movable object itself while eliminating the rays that are reflected only by the ground although originating from a transmitter of opportunity that is sought. The method makes it possible to take account of the rays reflected both by the ground and by the movable object, which makes it possible to map the electromagnetic field variations of a zone of the map to be established, a zone situated immediately next to the movable object. A singularity of the electromagnetic field can be understood to mean any transmission source or ray originating from a transmitter of opportunity and any reflection of this source. The direct transmissions originating from the sources and the reflections of the direct transmissions on characteristic points of the ground behave in the same way with respect to the passive radar. By crossing several probable zones of location of singularities, a map is obtained of objects that do not move relative to the passive radar. The direct transmissions and the reflected transmissions appear in the same manner on the map. They can be assimilated to bright points in the spectrum selected for the mapping. Moreover, the map thus obtained can reveal by variations of contrast the levels of the various transmissions received, which will make it possible to visualize the variations of the electromagnetic field in position and in level.

The mapping method according to the invention can be used with or without knowledge of the position of the transmitters of opportunity. Without knowledge of these positions, it is necessary to know the position of the movable objects. If these objects are for example airliners, it is possible to know their position by using a transmission system allowing automatic aircraft surveillance, well known in the English-language literature under the name of ADS-B for Automatic Dependent Surveillance-Broadcast. Through this system, the aircraft permanently transmits its position. Many other systems make it possible to know the position of movable objects such as for example, an active radar, a LIDAR, or a passive radar using the known position of transmitters of opportunity.

A method according to the invention can be used in real time, that is to say by simultaneously receiving the rays used in the distance Doppler matrix and the known positions of the movable object or objects. It is also possible to record rays received by the passive radar and cross them with records of trajectories of movable objects obtained on board the movable object for example by means of a GPS system, an inertial navigation unit or any other positioning means, these records being retrieved subsequently. It is thus sufficient to know, at precise moments, positions of movable objects and measurements of rays taken by the passive radar, the use of the method being able to be deferred.

The invention will be better understood and other advantages will appear on reading the detailed description of an embodiment given as an example, said description being illustrated by the appended drawing in which:

FIG. 1, already described above, makes it possible to explain a principle of locating a reflective object by means of a passive radar;

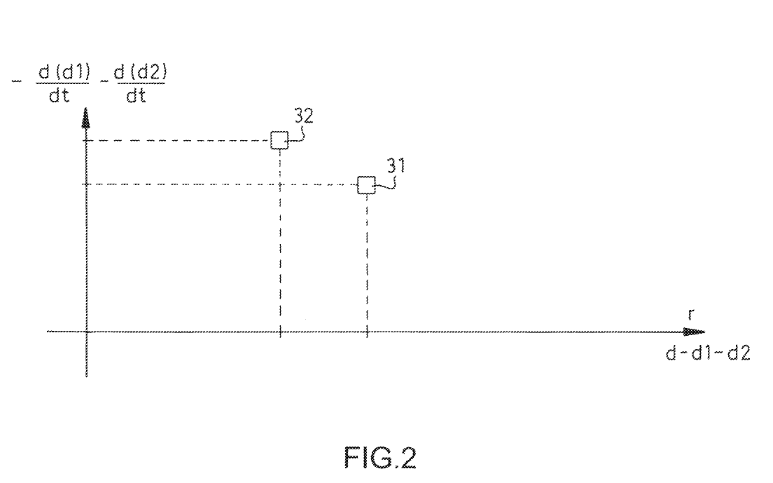

FIG. 2 represents an example of a distance Doppler matrix of the passive radar;

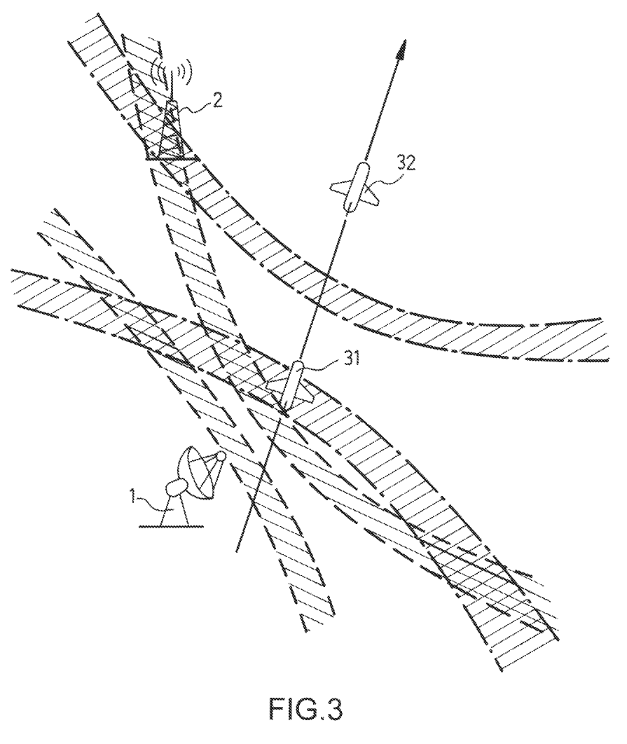

FIG. 3 illustrates an example of a map established with the aid of the passive radar.

For the purposes of clarity, the same elements will bear the same references in the various figures.

A method according to the invention operates continuously and receives multiple electromagnetic rays originating from several transmitters of opportunity. These rays are received either directly or after reflection on various objects. To understand the method better, the following explanation, illustrated with the aid of FIGS. 2 and 3, relates to a single transmitter 2 and to a single movable object 3. It is well understood that the accuracy of the mapping obtained by using a method according to the invention increases with the number of movable objects moving above the zone to be mapped.

As for FIG. 1, the radar 1 receives a first ray originating directly from a transmitter 2 and a second ray also originating from a transmitter 2 but reflected by a movable object 3, such as for example an aircraft overflying the zone to be mapped. The reflective power of the movable object 3 must be sufficient for the reflected ray to be captured by the radar 1. This is usually the case for an aircraft.

A distance Doppler matrix of the radar 1 is defined. This matrix is illustrated in FIG. 2. Represented on the abscissa is the bistatic d-d1-d2 distance and on the ordinate the bistatic speed:

$$- \frac{d ( d 1 )}{d t} - \frac{d ( d 2 )}{d t} .$$

A first position of the aircraft 3 is marked 31 and a second position of the aircraft 3 is marked 32.

As in the principle of location described with the aid of FIG. 1, a first ray originating directly from the transmitter 2 is captured and, for each position 31 and 32, a second ray originating from the transmitter 2 and reflected by the aircraft 3 is captured.

For each position 31 and 32 a deviation of distance r, or bistatic distance, separating a distance d traveled by the first ray and a sum of distance d1+d2 traveled by the second ray, the distance d1 being the distance traveled by the second ray between the transmitter 2 and the aircraft 3 in position 31 or 32, the distance d2 being the distance traveled by the second ray between the aircraft 3 in position 31 or 32 and the radar 1.

Also determined for each position 31 and 32 is a bistatic speed equal to the derivative of the deviation of distance r.

Then, the method consists in transferring to a map to be established a probable zone of location of the transmitter 2. This is a zone in which the transmitter 2 has a strong probability of being situated. For each position 31 and 32, the probable zone in which the transmitter 2 is situated is centered on a hyperboloid defined by:

d−d1=d2−r (3)

In FIG. 2, the probable zone for the position 31 is represented by a hatched zone limited by two hyperbolas represented in dashed line. The probable zone for the position 32 is represented by a hatched zone limited by two hyperbolas represented in dot and dash line. The transmitter 2 is situated on one of the intersections of the various probable zones.

The various probable zones move as a function of the trajectory of the movable object 3 but a single intersection between the various probable zones remains fixed. This intersection is centered on the position of the transmitter 2.

By displaying on the map only the points of which the occurrence of appearance in the probable zones is high, only the points situated at the fixed intersections appear on the map. The more aircraft there are moving in the zone to be mapped, the easier it will be to reveal the points of high occurrence. Tests have shown that after a few minutes of integration, the position of the transmitters capable of being received by the radar 1 appears on the map. By continuing the time of integration, other singularities of the landscape also appear. These singularities represent zones in which the ray originating from a transmitter is reflected more particularly as, for example, a mountainous relief or a high-voltage electric line. If the zones of high reflectivity are represented brightly on the map, by contrast, zones of low reflectivity also appear in low brightness. The crossing of several probable zones is an integration. The higher the number of probable zones, the more precise is the map.

The transfer to the map can be carried out either as a function of a known position of the movable object at the time of reception of the rays or as a function of known positions of other transmitters of opportunity.

Advantageously, a correction of intensity is established for the rays received by the passive radar 1 and all that is retained in the distance Doppler matrix are the points of which the correction is less than a given value. Specifically, when the passive radar 1 receives multiple rays, the weakening of the latter is a function of the square of the distance of the place of transmission and/or of reflection. A correction of intensity is therefore established in order to raise the level of signals which originate from a great distance. Nevertheless, beyond a certain distance, it is difficult to distinguish, within the ray received, the noise of the useful signal. Beyond a certain distance from the radar 1, the edges of the map appear uniformly illuminated. In order to prevent this phenomenon, no account is taken of the points for which the correction is greater than a given threshold. The value of this threshold may be defined experimentally.

Advantageously, a correlation is determined between the ray received directly and the reflected ray and all that is retained in the distance Doppler matrix are the points of which the correlation is greater than a given value. In this way the contribution of the rays originating from a transmitter of opportunity and reflected by the movable object is limited to a given envelope which, on first approximation, can be assimilated to a Cassini oval centered on the passive radar 1 and on the movable object 3. In other words, the movable object 3 makes it possible to obtain an image of the ground in the vicinity of its trajectory. The threshold value of the correlation may be defined experimentally.

Advantageously, for each point on the map, the value of an electromagnetic field of the possible singularity of this point is weighted as a function of the number of values integrated at this point. Specifically, when the threshold of correlation defined above is used, for example when the movable object is observed in two distinct positions, the user will obtain, for a given point on the map situated close to the radar 1, two measurements and a single measurement for a point on the map situated in the vicinity of each position of the movable object 3. In this case, a weighting of two will be applied to the points on the map situated in the vicinity of the radar 1.

1. A mapping method implementing a passive radar (1) and at least one movable object (3) capable of reflecting rays received from transmitters of opportunity (2), characterized in that it comprises the following operations:
determining, in a distance Doppler matrix of the radar (1), points relative to the deviations between the rays received directly from the transmitters (2) and the rays reflected by the movable object (3),
transferring to a map to be established a probable zone of location of singularities of the electromagnetic field transmitted or reflected by the ground,
crossing several probable zones during the movement of the movable object (3) in order to obtain the location of the singularities.

2. The method as claimed in claim 1, characterized in that the transfer to the map is carried out as a function of a known position of the movable object (3) at the time of receiving the rays.

3. The method as claimed in claim 1, characterized in that the transfer to the map is carried out as a function of the known positions of the transmitters of opportunity (2).

4. The method as claimed in one of the preceding claims, characterized in that a correction of intensity is established for the rays received by the passive radar (1) and in that all that is retained in the distance Doppler matrix are the points of which the correction is less than a given value.

5. The method as claimed in one of the preceding claims, characterized in that a correlation is determined between the directly-received ray and the reflected ray and in that all that is retained in the distance Doppler matrix are the points of which the correlation is greater than a given value.

6. The method as claimed in one of the preceding claims, characterized in that, for each point on the map, the value of an electromagnetic field of the possible singularity of this point is weighted as a function of the number of values integrated in this point.

7. The method as claimed in one of the preceding claims, characterized in that the singularities comprise the transmitters of opportunity (2).

8. The method as claimed in claim 7, characterized in that the singularities comprise reflecting points of the map.

9. The method as claimed in one of the preceding claims, characterized in that the singularities include rays originating from a transmitter of opportunity and any reflection of these rays.

10. The method as claimed in any one of claims 2 to 9, characterized in that it consists in simultaneously receiving the rays used in the distance Doppler matrix and the known positions of the movable object or objects.

11. The method as claimed in any one of claims 2 to 9, characterized in that it consists in receiving the rays used in the distance Doppler matrix and in subsequently retrieving records of positions of movable objects at the moments when the rays were received.
